(19) United States
(12) Patent Application Publication
(10) Pub. No.: US 2024/0125981 A1
(43) Pub. Date: Apr. 18, 2024

(54) OPTICAL LENS

(71) Applicant: GUANGZHOU LUXVISIONS INNOVATION TECHNOLOGY LIMITED, GUANGZHOU (CN)

(72) Inventors: Chuan-Hui Liu, Guangzhou (CN); Shih-Chieh Yen, Guangzhou (CN)

(73) Assignee: GUANGZHOU LUXVISIONS INNOVATION TECHNOLOGY LIMITED, GUANGZHOU (CN)

(21) Appl. No.: 18/165,344

(22) Filed: Feb. 7, 2023

(30) Foreign Application Priority Data
Oct. 14, 2022 (CN) 202211260944.3

(51) Int. Cl. G02B 3/00; G02B 3/08

(52) U.S. Cl. CPC G02B 3/0043; G02B 3/08

(57) ABSTRACT

An optical lens is provided, including a substrate and multiple phase delay structures. The phase delay structures are disposed on the substrate in an array. Each of the phase delay structures is circular, and includes a center of circle and multiple microstructures. Distances D between the two adjacent microstructures of each of the phase delay structures in a radial direction of the center of circle are the same, and at least two of the phase delay structures among the phase delay structures have the different distances D.

### CROSS-REFERENCE TO RELATED APPLICATION

This application claims the priority benefit of China application serial no. 202211260944.3, filed on Oct. 14, 2022. The entirety of the above-mentioned patent application is hereby incorporated by reference herein and made a part of this specification.

### BACKGROUND

### Technical Field

The disclosure relates to an optical element, and more particularly, to an optical lens.

### Description of Related Art

Due to the increasingly diverse demands for lens imaging in recent years, an application of an metalens has become more and more extensive. One of its characteristics is that it may greatly reduce a thickness of the lens. However, using the same microstructure array to refract full-color light will have an issue of low resolution, and for the light of different wave bands, it is impossible to clearly image at the same time. Therefore, there is an urgent demand to develop a metalens that may clearly image different colors of light.

### SUMMARY

The disclosure provides an optical lens, which provides different phase delays corresponding to different color lights, so that the different color lights may be clearly imaged.

According to an embodiment of the disclosure, an optical lens is provided, including a substrate and multiple phase delay structures. The phase delay structures are disposed on the substrate in an array. Each of the phase delay structures is circular, and includes a center of circle and multiple microstructures. Distances D between the two adjacent microstructures of each of the phase delay structures in a radial direction of the center of circle are the same, and at least two of the phase delay structures among the phase delay structures have the different distances D.

Based on the above, in the optical lens (metalens) provided in the embodiment of the disclosure, different phase delay structures are used to refract different color lights (wave bands). Compared to the conventional technology where the same phase delay structure is used to refract different color lights, each of the color lights in the embodiment of the disclosure may have appropriate phase delay respectively, and each of the color lights may be clearly imaged.

In order for the aforementioned features and advantages of the disclosure to be more comprehensible, embodiments accompanied with drawings are described in detail below.

### BRIEF DESCRIPTION OF THE DRAWINGS

FIG. 1 is a schematic view of imaging of an optical system according to an embodiment of the disclosure.

FIG. 2 is a schematic plan view of an optical lens according to an embodiment of the disclosure.

FIGS. 3A, 3B, and 3C are partial cross-sectional views of an optical lens according to an embodiment of the disclosure.

FIG. 4 is a partial plan view of an optical lens according to an embodiment of the disclosure.

FIG. 5 is a partial plan view of an optical lens according to an embodiment of the disclosure.

FIG. 6 is a graph of a relationship between a microstructure width and phase delay according to an embodiment of the disclosure.

FIGS. 7A to 7D are schematic views of phase delay of a phase delay structure according to an embodiment of the disclosure.

FIGS. 8A to 8C are graphs of various aberrations of a phase delay structure according to an embodiment of the disclosure.

### DETAILED DESCRIPTION OF DISCLOSED EMBODIMENTS

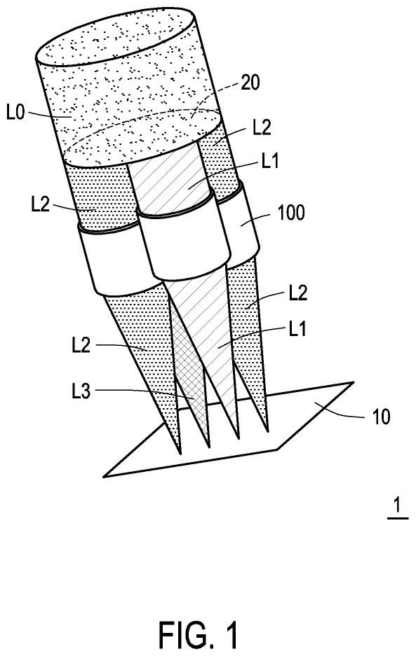

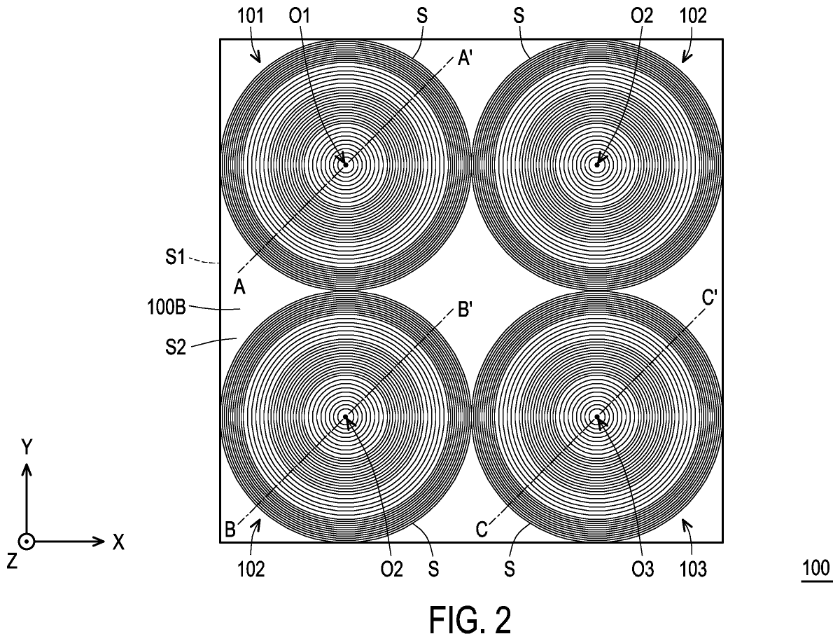

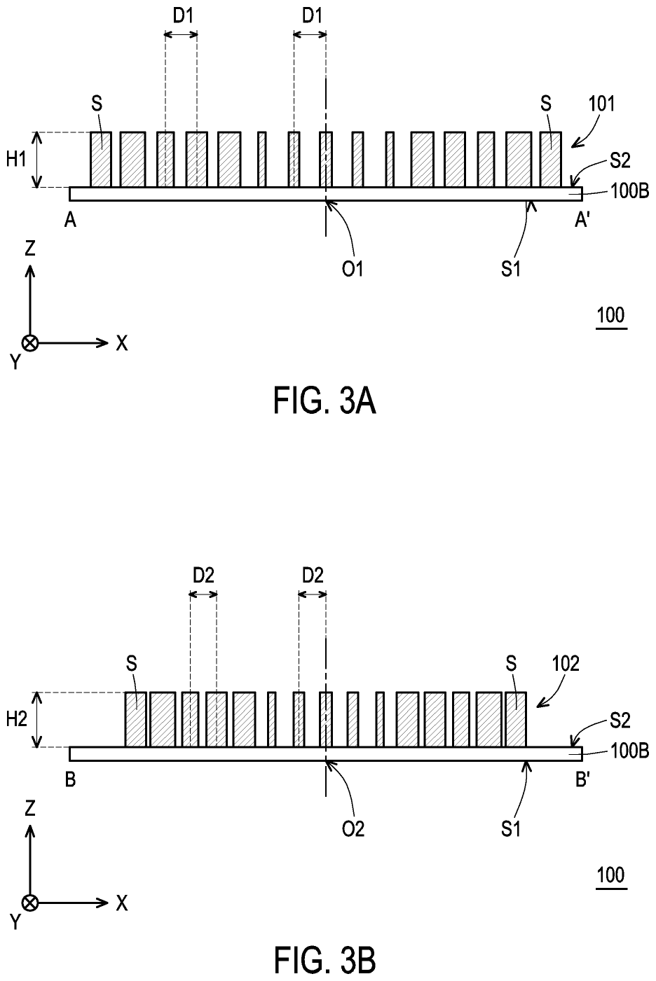

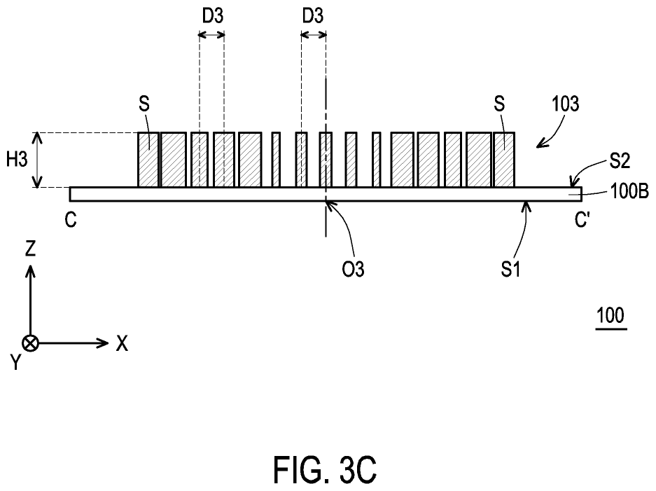

Referring to FIGS. 1 to 3C, FIG. 1 is a schematic view of imaging of an optical system according to an embodiment of the disclosure. FIG. 2 is a schematic plan view of an optical lens according to an embodiment of the disclosure. FIGS. 3A, 3B, and 3C are partial cross-sectional views of an optical lens according to an embodiment of the disclosure.

An optical system 1 includes a sensor 10, a color resist array 20, and an optical lens 100. The optical lens 100 includes a substrate 100B, a phase delay structure 101, two phase delay structures 102, and a phase delay structure 103. The four phase delay structures 101 to 103 are disposed in an array on the substrate 100B, and as shown in FIG. 2, each of the phase delay structures 101, 102, and 103 is circular and includes multiple microstructures S. In each of the phase delay structures 101, 102, and 103, the microstructures S are sequentially arranged along a radial direction from a center of circle to which they belong.

It should be noted that when light (an electromagnetic wave) penetrates the phase delay structures 101, 102, or 103, an amplitude and a phase of the light are changed due to the array formed by the microstructures S, thereby changing a traveling direction of the light to achieve a purpose of refraction. Therefore, each of the phase delay structures 101, 102, and 103 may be equivalent to a lens with a diopter. In the embodiment shown in FIG. 1, the phase delay structures 101 to 103 are all used as convergent lenses. However, the disclosure is not limited thereto. In other embodiments, the four phase delay structures 101 to 103 may be used as divergent lenses. In some embodiments, a refractivity of each of the microstructures S falls within a range of 2 to 3, and a material thereof is, for example, gallium nitride (GaN). However, the disclosure is not limited thereto.

The color resist array 20 is used as a color filter of an incident light L0 to generate a first color light L1, a second color light L2, and a third color light L3 that are spatially separated. Colors (wave bands) of the first color light L1, the second color light L2, and the third color light L3 are different from one another. The phase delay structure 101 is used to converge the first color light L1 on the sensor 10. The two phase delay structures 102 are used to converge the two separate second color lights L2 on the sensor 10 respectively. The phase delay structure 103 is used to converge the third color light L3 on sensor 10.

In this embodiment, the optical lens 100 includes the four phase delay structures 101 to 103. However, the disclosure is not limited thereto. In other embodiments, the optical lens 100 may include multiple phase delay structures, and the number is not limited to four. For example, there may be two, three, or five phase delay structures.

Referring to FIGS. 2 and 3A to 3C, FIG. 3A is a schematic cross-sectional view of the phase delay structure 101 in FIG. 2 taken along a line AA′. The line AA′ passes through a center of circle O1 of the phase delay structure 101. The substrate 100B has a first surface S1 and a second surface S2 opposite to the first surface S1, and the microstructures S of the phase delay structure 101 are disposed on the second surface S2. It may be seen that a distance between the two adjacent microstructures S in the phase delay structure 101 in the radial direction of the phase delay structure 101 is D1 (hereinafter referred to as a first distance D1), and D1 is a constant value. FIG. 3B is a schematic cross-sectional view of the phase delay structure 102 in FIG. 2 taken along a line BB′. The line BB′ passes through a center of circle O2 of the phase delay structure 102. The microstructures S of the phase delay structure 102 are also disposed on the second surface S2. It may be seen that a distance between the two adjacent microstructures S in the phase delay structure 102 in the radial direction of the phase delay structure 102 is D2 (hereinafter referred to as a second distance D2), and D2 is a constant value. FIG. 3C is a schematic cross-sectional view of the phase delay structure 103 in FIG. 2 taken along a line CC′. The line CC′ passes through a center of circle O3 of the phase delay structure 103. The microstructures S of the phase delay structure 103 are also disposed on the second surface S2. It may be seen that a distance between the two adjacent microstructures S in the phase delay structure 103 in the radial direction of the phase delay structure 103 is D3 (hereinafter referred to as a third distance D3), and D3 is a constant value.

It should be noted that, in order to enable the first color light L1, the second color light L2, and the third color light L3 to be clearly imaged on the sensor 10, the first distance D1, the second distance D2, and the third distance D3 are different from one another. Specifically, in some embodiments, when a dominant wavelength λ1 of the first color light L1 is greater than a dominant wavelength λ2 of the second color light L2, and the dominant wavelength λ2 of the second color light L2 is greater than a dominant wavelength λ3 of the third color light L3, the first distance D1 is greater than the second distance D2, and the second distance D2 is greater than the third distance D3. For example, in an embodiment, the first color light L1, the second color light L2, and the third color light L3 are red light, green light, and blue light, respectively. The dominant wavelengths λ1, λ2, and λ3 are 640 nm, 520 nm, and 460 nm, respectively. The first distance D1, the second distance D2, and the third distance D3 are 350 nm, 250 nm, and 200 nm, respectively. In another embodiment, the first color light L1, the second color light L2, and the third color light L3 are red light, yellow light, and blue light, respectively. The dominant wavelengths λ1, λ2, and λ3 are 640 nm, 580 nm, and 460 nm, respectively. The first distance D1, the second distance D2, and the third distance D3 are 350 nm, 300 nm, and 200 nm, respectively.

A relationship between the dominant wavelengths λ1, λ2, and λ3 of each of the color lights and the distances D1, D2, and D3 of the microstructures is not limited to the above exemplary embodiments. According to some embodiments of the disclosure, when the first distance D1 of the phase delay structure 101 and the dominant wavelength λ1 of the first color light L1 meet a conditional formula λ1/2.5<D1<λ1/1.5, the second distance D2 of the phase delay structure 102 and the dominant wavelength λ2 of the second color light L2 meet a conditional formula λ2/2.5<D2<λ2/1.5, and the third distance D3 of the phase delay structure 103 and the dominant wavelength λ3 of the third color light L3 meet a conditional formula λ3/2.5<D3<λ3/1.5, the first color light L1, the second color light L2, and the third color light L3 may all be clearly imaged, and a spot size of a central field of view of each of the color lights is smaller than a size of an Airy disk, which meets imaging requirements.

According to some embodiments of the disclosure, a vertical height H1 of the microstructure S relative to the second surface S2 in FIG. 3A, a vertical height H2 of the microstructure S relative to the second surface S2 in FIG. 3B, and a vertical height H3 of the microstructure S relative to the second surface S2 in FIG. 3C all fall within a range of 500 nm to 1100 nm. In some embodiments, the heights H1, H2, and H3 all fall within a range of 900 nm to 1100 nm.

Referring to FIGS. 2, 3A to 3C, and 4 together, FIG. 4 is a partial plan view of an optical lens according to an embodiment of the disclosure. An optical lens 400 includes a substrate 400B and a phase delay structure 401, and the microstructures S of the phase delay structure 401 are rings. Each of the rings is disposed with a center of circle O4 of the phase delay structure 401 as a symmetrical center. In some embodiments, any of the phase delay structures 101 to 103 in FIG. 2 may be implemented with the phase delay structure 401, and FIGS. 3A to 3C are schematic cross-sectional views of the phase delay structure 401 taken along a line EE′.

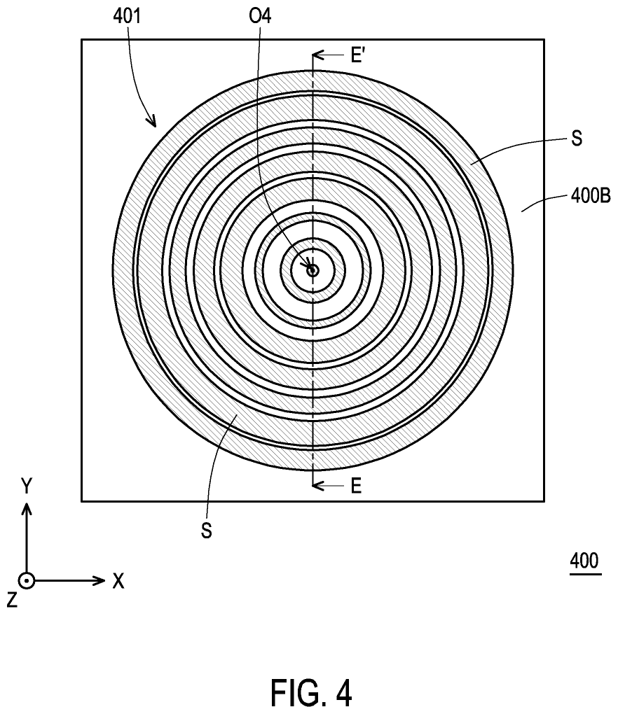

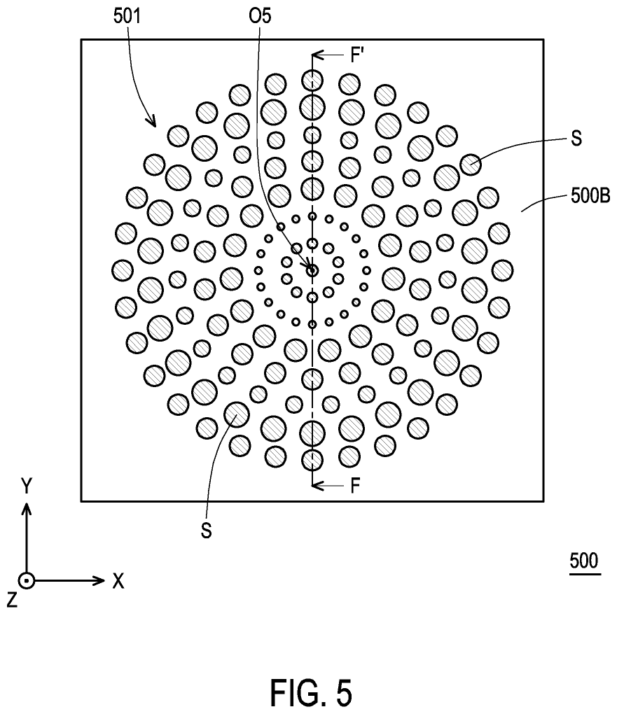

Referring to FIGS. 2, 3A to 3C, and 5 together, FIG. 5 is a partial plan view of an optical lens according to an embodiment of the disclosure. An optical lens 500 includes a substrate 500B and a phase delay structure 501, and the microstructures S of the phase delay structure 501 are cylinders. In order to conform to the space symmetry, among the cylinders, the cylinders with the same distance from a center of circle O5 of the phase delay structure 501 have the same width (i.e., a diameter of the cylinder) in the radial direction of the phase delay structure 501. More specifically, in order to conform to the space symmetry, among the cylinders, the cylinders with the same distance from the center of circle O5 of the phase delay structure 501 have the same shape, diameter, and height. In some embodiments, any of the phase delay structures 101 to 103 in FIG. 2 may be implemented with the phase delay structure 501, and FIGS. 3A to 3C are schematic cross-sectional views of the phase delay structure 501 taken along a line FF.

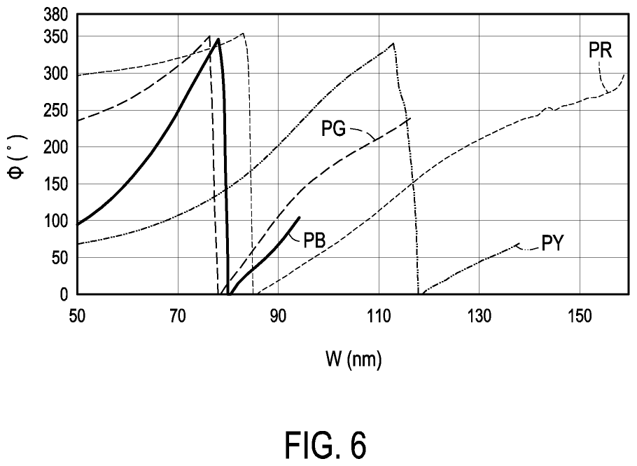

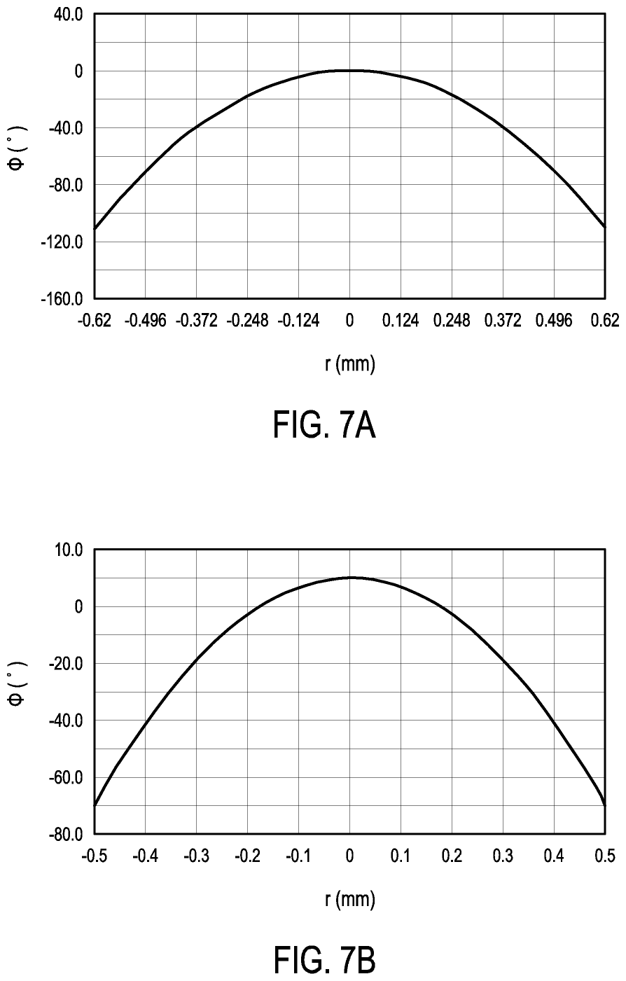

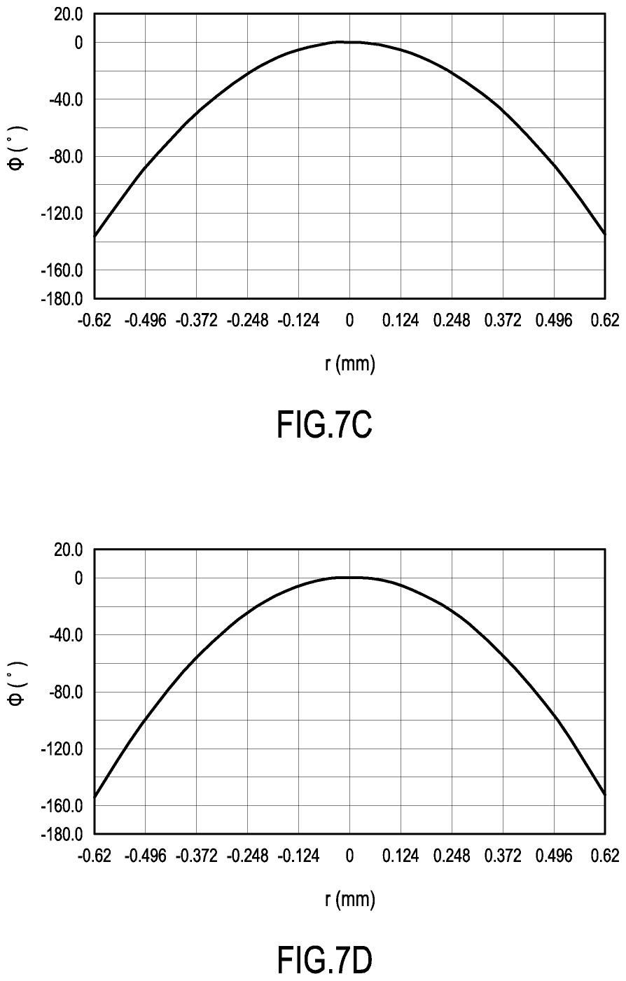

Next, referring to FIGS. 1, 2, 3A to 3C, 6, 7A, 7B, 7C, and 7D together to understand a creative concept of the disclosure. FIG. 6 is a graph of a relationship between a microstructure width and phase delay according to an embodiment of the disclosure. FIGS. 7A to 7D are schematic views of phase delay of a phase delay structure according to an embodiment of the disclosure.

As mentioned above, in the embodiment shown in FIG. 1, the phase delay structures 101 to 103 are all used as the convergent lenses. Therefore, distribution graphs of phase delay of the phase delay structures 101 to 103 are as shown in FIGS. 7A to 7D. Specifically, taking FIG. 7A as an example, it exemplarily shows a phase delay Φ caused by the phase delay structure 101 of one embodiment to the red light with the dominant wavelength of 640 nm. At a radius r=0 (that is, the center of circle O1 of the phase delay structure 101), phase delay of the red light will not occur. As the radius r increases (that is, the farther away from the center of circle O1), the greater the phase delay of the red light will occur. As a result, the phase retardation structure 101 has the same refractive power as one convergent lens.

Similarly, FIG. 7B exemplarily shows the phase delay Φ caused by the phase delay structure 102 of one embodiment to the yellow light with the dominant wavelength of 580 nm. FIG. 7C exemplarily shows the phase delay Φ caused by the phase delay structure 102 of one embodiment to the green light with the dominant wavelength of 520 nm. FIG. 7D exemplarily shows the phase delay Φ caused by the phase delay structure 103 of one embodiment to the blue light with the dominant wavelength of 460 nm. As shown in the figures, the phase delay structures have the same refractive power as one convergent lens.

In order to achieve the phase delay shown in FIGS. 7A to 7D, each of the microstructures of the corresponding phase delay structures are required to be disposed according to the graph shown in FIG. 6. Specifically, in FIG. 6, a horizontal axis represents a width W of the microstructure in the radial direction of the phase delay structure (hereinafter referred to as a radial width W), that is, the width of any of the microstructures S in an X direction in FIGS. 3A to 3C, and a vertical axis represents the phase delay caused by the microstructure to the light. A curve PR is a simulation result for the red light with the dominant wavelength of 640 nm. A curve PY is a simulation result for the yellow light with the dominant wavelength of 580 nm. A curve PG is a simulation result for the green light with the dominant wavelength of 520 nm. A curve PB is a simulation result for the blue light with the dominant wavelength of 460 nm.

In other words, when the curve shown in FIG. 7A is used as a target curve, the radial width W of the microstructure S of the phase delay structure 101 at the radius r may be determined by the curve PR in FIG. 6. When the curve shown in FIG. 7B is used as the target curve, the radial width W of the microstructure S of the phase delay structure 102 at the radius r may be determined by the curve PY in FIG. 6. When the curve shown in FIG. 7C is used as the target curve, the radial width W of the microstructure S of the phase delay structure 102 at the radius r may be determined by the curve PG in FIG. 6. When the curve shown in FIG. 7D is used as the target curve, the radial width W of the microstructure S of the phase delay structure 103 at the radius r may be determined by the curve PB in FIG. 6.

According to some embodiments of the disclosure, as shown in FIG. 6, a ratio of the wavelength of each of the color lights to the radial width of any of the microstructures falls within a range of 1 to 15. In addition, in some embodiments, a ratio of the height of any of the microstructures relative to the second surface S2 to the radial width W thereof falls within a range of 1 to 8, but the disclosure is not limited thereto.

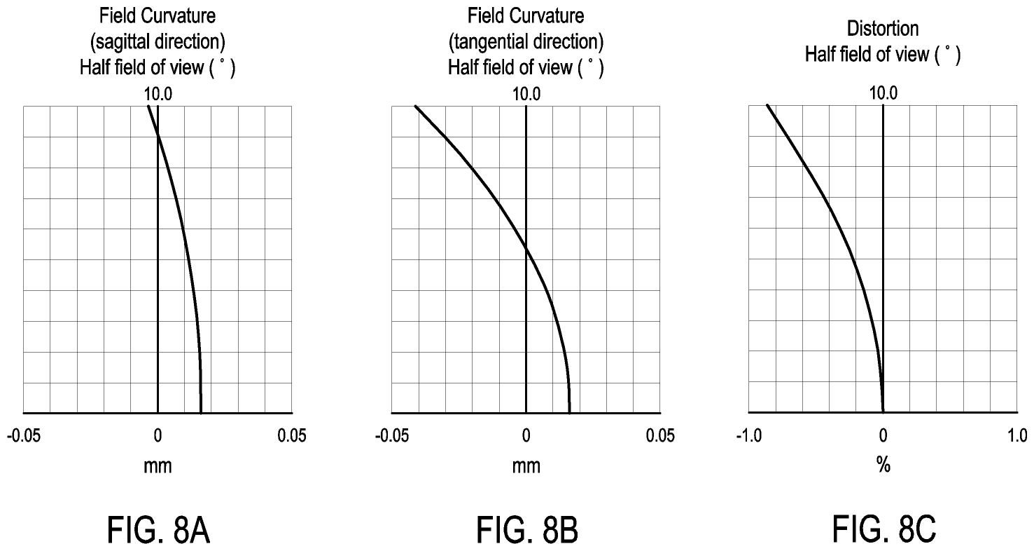

Refer to FIGS. 1, 8A to 8C, and Table 1 together, in an embodiment, a refractivity of the substrate 100B is 1.458, a thickness is 1.0 mm, and an Abbe number is 67.821. A distance between the second surface S2 and the sensor 10 is 2.660 mm, and binary coefficients of the second surface S2 are shown in Table 1.

TABLE 1

| Wavelength (nm) | p² | p⁴ | p⁶ | p⁸ |
|---|---|---|---|---|
| 460 | −6.38E+06 | 6.64E+08 | −3.07E+12 | 7.76E+15 |
| 520 | −5.64E+06 | 5.83E+08 | −2.67E+12 | 6.72E+15 |
| 640 | −4.59E+06 | 4.70E+08 | −2.13E+12 | 5.31E+15 |

Taking the green light with a central wavelength of 520 nm as an example, FIGS. 8A and 8B show a field curvature aberration in a sagittal direction and a field curvature aberration in a tangential direction, respectively. FIG. 8C shows a distortion aberration.

In the graphs of the two field curvature aberrations in FIGS. 8A and 8B, the field curvature aberration falls within ±0.05 mm, which shows that the optical system in the embodiment of the disclosure may effectively eliminate the aberration. The graph of the distortion aberration in FIG. 8C shows that the distortion aberration is maintained within ±1%, which shows that the optical system in the embodiment of the disclosure has good imaging quality.

Based on the above, in the optical lens provided in the embodiments of the disclosure, different phase delay structures are used to refract different color lights. Compared to the conventional technology where the same phase delay structure is used to refract different color lights, each of the color lights in the embodiment of the disclosure may have appropriate phase delay respectively, and each of the color lights may be clearly imaged.

What is claimed is:

1. An optical lens, comprising:
a substrate; and
a plurality of phase delay structures disposed on the substrate in an array, wherein each of the phase delay structures is circular and comprises a center of circle and a plurality of microstructures,
wherein distances D between the two adjacent microstructures of each of the phase delay structures in a radial direction of the center of circle are the same, and at least two of the phase delay structures among the phase delay structures have the different distances D.

2. The optical lens according to claim 1, wherein each of the phase delay structures is a convergent lens.

3. The optical lens according to claim 1, wherein the microstructures are a plurality of rings.

4. The optical lens according to claim 1, wherein the microstructures are a plurality of cylinders, and among the cylinders, the cylinders with a same distance from the corresponding center of circle has a same width in the radial direction.

5. The optical lens according to claim 1, wherein the phase delay structures comprise a first phase delay structure, a second phase delay structure, and a third phase delay structure, and have the different distances D respectively.

6. The optical lens according to claim 5, wherein the first phase delay structure, the second phase delay structure, and the third phase delay structure are configured to generate phase delay for a red color light, a green color light, and a blue color light respectively.

7. The optical lens according to claim 6, wherein the distances D of the first phase delay structure, the second phase delay structure, and the third phase delay structure and a corresponding wavelength λ of the color light meet a conditional formula λ/2.5<D<λ/1.5.

8. The optical lens according to claim 5, wherein the first phase delay structure, the second phase delay structure, and the third phase delay structure are configured to generate phase delay for a red color light, a yellow color light, and a blue color light respectively.

9. The optical lens according to claim 8, wherein the distances D of the first phase delay structure, the second phase delay structure, and the third phase delay structure and a corresponding wavelength λ of the color light meet a conditional formula λ/2.5<D<λ/1.5.

10. The optical lens according to claim 5, wherein effective focal lengths of the first phase delay structure, the second phase delay structure, and the third phase delay structure are the same.

11. The optical lens according to claim 1, wherein the phase delay structures are respectively configured to generate phase delay for a plurality of color lights, and a ratio of a wavelength of each of the color lights to a width of the microstructures in the corresponding phase delay structure in the radial direction falls within a range of 1 to 15.

12. The optical lens according to claim 1, wherein a ratio of a height of each of the microstructures in a normal direction of the substrate to a width thereof in the radial direction falls within a range of 1 to 8.

13. The optical lens according to claim 1, wherein a refractivity of each of the microstructures falls within a range of 2 to 3.

14. The optical lens according to claim 1, wherein a height of each of the microstructures in a normal direction of the substrate falls within a range of 500 nm to 1100 nm.
